(19) United States
(12) Patent Application Publication
(10) Pub. No.: US 2025/0323453 A1
(43) Pub. Date: Oct. 16, 2025

(54) LOCKBOX FOR AN ELECTRIC VEHICLE CHARGING CONNECTOR

(71) Applicant: EVchargeME.com Inc., Littleton, CO (US)

(72) Inventor: John Douglas PATTERSON, Denver, CO (US)

(21) Appl. No.: 18/922,904

(22) Filed: Oct. 22, 2024

Related U.S. Application Data
(60) Provisional application No. 63/633,402, filed on Apr. 12, 2024.

(51) Int. Cl. H01R 13/60; B60L 53/30; G07C 9/00; G07C 9/20; H01R 13/73

(52) U.S. Cl. CPC H01R 13/60; B60L 53/30; G07C 9/00309; G07C 9/20; H01R 13/73; B60L 2270/34

(57) ABSTRACT

A lockbox for an electric vehicle charging connector, comprising a housing having a base member and a cover member operatively arranged to be connected to one another to form a compartment, the base member having a floor, the cover member having a ceiling; a latch fixedly secured to the ceiling, the latch having an aperture therein, a linear actuator secured to the floor, the linear actuator typically having a screw or rod, the linear actuator operatively arranged to extend the screw through the aperture to lock the cover member to the base member, a computer processor operatively arranged to control the linear actuator, and, a Bluetooth® transceiver or other suitable transceiver mounted within the lockbox, operatively arranged to receive a signal from a mobile device and to communicate the signal to the computer processor to verify the signal and control the linear actuator.

### CROSS-REFERENCE TO RELATED APPLICATIONS

This application claims priority to and the benefit of Provisional U.S. application 63/633,402 titled LOCKBOX FOR AN ELECTRIC VEHICLE CHARGING CONNECTOR filed on Apr. 12, 2024, which is incorporated herein by reference in its entirety.

### FIELD OF THE INVENTION

The invention relates generally to a lockbox for an electric vehicle charging connector.

### BACKGROUND

Electric vehicles (EVs) have become increasingly popular due to their environmental friendliness and cost-effectiveness. However, to keep EVs running, they must be charged regularly. An EV charger is a device that provides electrical energy to recharge the batteries of electric vehicles.

Electric vehicle charging connectors are devices that supply electricity to the batteries of electric vehicles. They come in different types, including level 1, level 2, and level 3 chargers. Level 1 electric vehicle chargers provide up to 120 volts of alternating current (AC) and up to 2.4 kilowatts (kW) of power. Level 2 chargers provide up to 240 volts of alternating current (AC) power and up to 19 kilowatts (kW) of power. Level 3 chargers provide up to 480 volts of direct current (DC) and up to 350 kilowatts (kW) of power.

Electric vehicle chargers include a power supply to provide the desired type and magnitude of voltage/current/power to the battery to be charged. The charger is connected to the battery via a connector. The connector comprises a plug, which is inserted into the electric vehicle's charging port, and the socket. The plug and socket have pins that match and connect to form an electrical circuit. These pins can handle a range of high currents and voltages without overheating or causing electrical arcing.

Several different types of connectors are available, including:
Type 1 (SAE J1772): This connector has five pins and is common in North America and Japan. It has a relatively low power rating (up to 16 amps), which makes it suitable for slow and medium-speed charging systems.
Type 2 (IEC 62196): This type of connector has seven pins, and is common in Europe and Australia mainly use it. It supports higher power levels (up to 43 kW), which makes it suitable for fast charging.
CHAdeMO: This connector is used mainly in vehicles for DC fast charging and is prevalent in Japan. Its unique “gun” shape can supply electricity at up to 62.5 kW of power.
CCS: Combined Charging System (CCS) is a standardized connector that combines the Type 2 AC connector with two additional DC pins. It is becoming more prevalent in vehicles worldwide and supports charging up to 350 kW.
Tesla: This proprietary connector is used exclusively by Tesla vehicles. It features a unique design with five pins for AC charging and additional pins for DC fast charging, allowing for versatile use across different charging speeds. Tesla connectors support both standard and high-power Supercharging, delivering power up to 250 kW.
NACS: NACS or North American Charging Standard is a unified electric vehicle charging connector and protocol designed to streamline charging across different manufacturers and improve compatibility and efficiency for EV users.

As electric vehicles and charging stations become more common, a need has arisen to protect and secure the connectors, especially when the chargers are located in a public space or external to a private residence or business. Specifically, there is a need to protect the connectors both from environmental factors and from unauthorized access.

### SUMMARY OF THE INVENTION

The invention broadly comprises a lockbox for an electric vehicle charging connector, comprising a housing having a base member and a cover member operatively arranged to be connected to one another to form a compartment, the base member having a floor, the cover member having a ceiling; a latch fixedly secured to the ceiling, the latch having an aperture therein, a linear actuator secured to the floor, the linear actuator having a screw or rod, the linear actuator operatively arranged to extend the screw or rod through the aperture to lock the cover member to the base member, a computer processor operatively arranged to control the linear actuator, and, in preferred embodiments, a Bluetooth® transceiver mounted within the lockbox, operatively arranged to receive a signal from a mobile device and to communicate the signal to the computer processor to verify the signal and control the linear actuator. Other transceiver types can be used. Other methods to operate the linear actuator may be used such as, but not limited to, electromagnetic fields, air pressure, fluid pressure, and rotary pinions.

In a second embodiment, the invention comprises the lockbox for the electric vehicle charging connector, comprising the housing having the base member and the cover member hingedly connected to one another, the base member having the floor and the base sidewall emanating substantially perpendicularly upwardly from the floor, the cover member having the ceiling and a lip emanating substantially perpendicularly downwardly from the ceiling, the latch fixedly secured to the ceiling, the latch having the aperture therein, the linear actuator secured to the floor, the linear actuator having the screw or rod, the linear actuator operatively arranged to extend the screw or rod through the aperture to lock the cover member to the base member, and a first bracket mounted to the floor, the first bracket operatively arranged to hold the electric vehicle charging connector, an infrared sensor mounted within the lockbox, operatively arranged to sense if the connector is being held within the first bracket, the computer processor operatively arranged to control the linear actuator; and, in preferred embodiments, the Bluetooth® transceiver mounted within the lockbox, operatively arranged to receive the signal from the mobile device and to communicate the signal to the computer processor to verify the signal and control the linear actuator. Other transceiver types can be used. Other methods to operate the linear actuator may be used such as, but not limited to, electromagnetic fields, air pressure, fluid pressure, and rotary pinions.

In a third embodiment, the invention broadly comprises the lockbox for the electric vehicle charging connector, comprising the housing having the base member and the cover member hingedly connected to one another, the base member having the floor and the base sidewall emanating substantially perpendicularly upwardly from the floor, the cover member having the ceiling and the lip emanating substantially perpendicularly downwardly from the ceiling, the latch fixedly secured to the ceiling, the latch having the aperture therein, the linear actuator secured to the floor, the linear actuator having the screw or rod, the linear actuator operatively arranged to extend the screw or rod through the aperture to lock the cover member to the base member, the first bracket mounted to the floor, the first bracket operatively arranged to hold the electric vehicle charging connector, the infrared sensor mounted within the lockbox, operatively arranged to sense if the electric vehicle charging connector is being held within the first bracket, and, the computer processor operatively arranged to control the linear actuator and to lock the lockbox only when the infrared sensor indicates that the electric vehicle charging connector is being held in the first bracket. Other transceiver types can be used. Other methods to operate the linear actuator may be used such as, but not limited to, electromagnetic fields, air pressure, fluid pressure, and rotary pinion systems.

The invention also comprises a method of operating the electric vehicle charging connector in the lockbox, including the steps of receiving the signal containing a code from the mobile device with the receiver located inside the lockbox, comparing the received code with a stored code to confirm that the received code matches the stored code, and activating the linear actuator to unlock the lockbox if and only if the received code matches the stored code. The method may further include estimating the charge used to charge the electric vehicle and recording the estimated charge. The method may further include sensing that said electric vehicle charging connector is inside said lockbox and activating the linear actuator to lock said lockbox.

A general object of the invention is to provide a lockbox for the electric vehicle charging connector that is operatively arranged to unlock the box when a user transmits an authorization code to a receiver inside the box.

A secondary object of the invention is to provide a lockbox for the electric vehicle charging connector that is operatively arranged to sense the presence of the electric vehicle charging connector inside the box and to lock the box after use only if the electric vehicle charging connector is sensed to be inside the box. This prevents a user from using the electric vehicle charging connector and then stealing it instead of placing it back inside the box after use.

A third object of the invention in preferred embodiments is to provide a lockbox that is or can be self-powered or battery operated totally or periodically wherein the locking mechanisms and the other such features need not depend, for all embodiments, on proximity to an electrical outlet. These embodiments are designed with the intent, as an object of these embodiments, to have a lower fire risk than otherwise comparable embodiments that are plugged into an outlet or during which time they may be plugged into an electrical outlet.

These and other objects, features, and advantages of the present invention will become readily apparent to those having skill in the art upon reading the following detailed description of the invention together with the claims and drawings.

### BRIEF DESCRIPTION OF THE DRAWINGS

The nature and mode of the operation of the present invention will now be more fully described in the following detailed description of the invention taken with the accompanying drawing figures. It should be understood that these drawings only depict preferred embodiments of the present invention and are not therefore to be considered limiting in scope, thus, the invention will be described with additional specificity and detail through the use of the accompanying drawings in which:

FIGS. 1A-1B are perspective views of the disclosed lockbox in an open state;

FIG. 2 is a perspective view of the disclosed lockbox in a closed state;

FIG. 3 are representative charging port types;

FIG. 4 are representative electric vehicle charging connector adapters;

FIG. 5 is a representative charging station;

FIG. 6 is a representative computer system;

FIGS. 7A-7B is a representative method for using disclosed lockbox;

FIG. 8 is a representative Bluetooth® chip circuit;

FIG. 9 illustrates a representative power supply circuit;

FIG. 10 is a representative door lock circuit;

FIG. 11 is representative External IO circuitry;

FIG. 12 is a representative Bluetooth® Low Energy (BLE) Microcontroller;

FIG. 13 is a representative RFID reader; and

FIG. 14 is a representative NFC reader.

### DETAILED DESCRIPTION OF THE INVENTION

The following is a detailed description of the present invention, including several embodiments thereof. Both apparatus and methods are disclosed and described. It should be understood that this description is not limited to the particular methodology, materials, and modifications described and, as such, may, of course, vary. It is also understood that the terminology used herein is for the purpose of describing particular aspects only and is not intended to limit the scope of the claims. Furthermore, it should be appreciated that drawings are representative to illustrate the inventive concepts herein and may not be to scale. Also, like drawing numbers on different drawing views identify identical, or functionally similar, structural elements where there could appear some variations on exactness where exactness is not material to the inventive concept herein.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. It should be appreciated that the term “distal” and comparably related terms denoting further-away portions of an item are antonymous to proximal portions of the co-described item as those portions of items may be termed. The term “approximately” is intended to mean values within ten percent of the specified value.

It should be understood that the use of “or” in the present application is with respect to a “non-exclusive” arrangement unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, when referring to a set or group of items, for illustration (A, B, C) the term “at least one or more . . . and . . . ” such as in “at least one or more of A, B, and C” is intended to include any to all of the denoted set or group of items, i.e. it could include just one item from the set or group, it could include all of the items from the set or group, and it could include any other combination of the set or group of items that is greater than one item and less than all of the items, the illustrated example having three items meaning there are up to seven non-ordered combinations A, B, C, AB, AC, BC, ABC. Other numbers of items would have maximum combination possibilities calculated accordingly.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

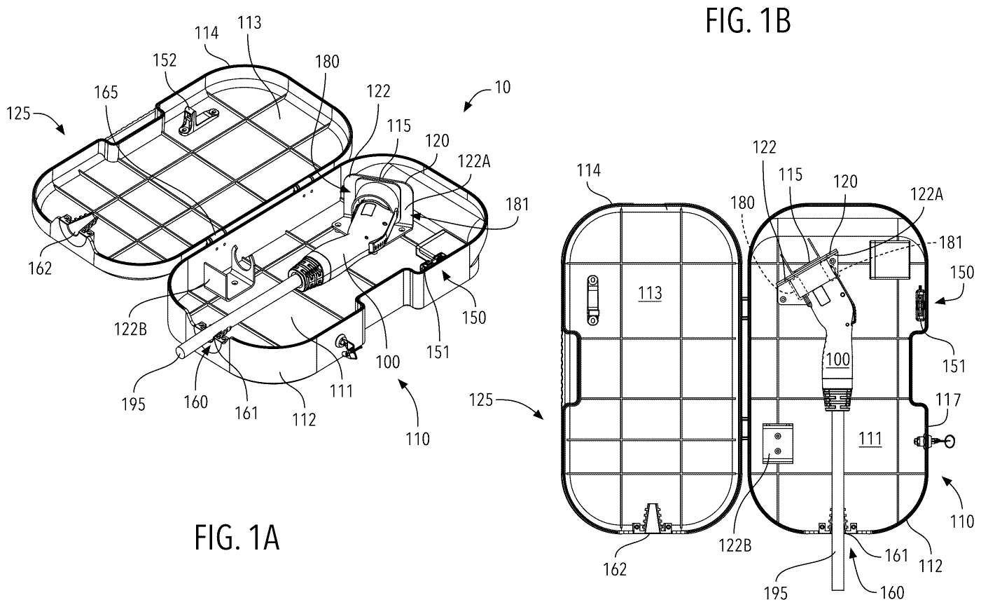

Disclosed in FIGS. 1A and 1B is lockbox 10 for electric vehicle charging connector 100 which includes housing 110, which is a compartment assembly designed to be in an open or a closed state and designed to contain at least one electric vehicle charging connector 100. Housing 110 is typically made from a polymer but may be metallic or ceramic or include metallic or ceramic parts. In some embodiments, housing 110 could be a clamshell-type design, and in other embodiments, housing 110, when in an open state, might present a door- or lid-type design for entry into housing 110.

At least one holder assembly 120 is designed to hold electric vehicle charging connector 100 within housing 110. This holder assembly 120 could be bracket 122 or other fixed holder assembly 120 which may hold a variety of electric vehicle charging connector 100 types or may be specialized for a particular electric vehicle charging connector 100 design, and holder assembly 120 could be all or part a hook and loop assembly or magnet-based attachment assembly.

FIGS. 1A and 1B further illustrate a representative embodiment of lockbox 10 for electric vehicle charging connector 100. This representative embodiment includes housing 110, housing 110 having base member 117, base member 117 having floor 111 and base sidewall 112, base sidewall 112 emanating perpendicularly upwardly from floor 111 and extending about a perimeter of housing 110. First bracket 122A is mounted to floor 111, first bracket 122A operatively arranged to hold electric vehicle charging connector 100, in some embodiments further around a coupler 115 portion of electric vehicle charging connector 100. Illustrated lockbox 10 has dimensions of about 22 inches by 12 inches by 4.25 inches, but other dimensions can readily be used. In some embodiments, at least a portion of housing 110 may be transparent. Infrared (IR) emitter 180 current and Infrared (IR) sensor 181 are located across from each other, in one embodiment within holder 120, where electric vehicle charging connector 100 can break an IR beam when inserted into holder 120.

Cover 125 of representative lockbox 10 is hingedly, by way of at least one hinge 165, secured to base sidewall 112 and operatively arranged to close housing 110 and cover electric vehicle charging connector 100 when electric vehicle charging connector 100 is held in first bracket 122A, cover 125 having ceiling 113 and lip 114, lip 114 emanating perpendicularly upwardly from ceiling 113 and extending about perimeter of cover 125. Latch 152 is mounted to ceiling 113 of cover 125.

Linear actuator 150, this being a motorized locking mechanism, is fixedly secured to floor 111 of housing 110, linear actuator 150 operatively arranged to engage latch 152 to lock lockbox 10 when cover 125 is closed with electric vehicle charging connector 100 held in first bracket 122A, wherein base sidewall 112 includes first notch 161 and lip 114 includes second notch 162 in registration with first notch 161, first notch 161 and second notch 162 arranged to form aperture 160 when lockbox cover 125 is closed, aperture 160 arranged for passage of charging cable 195 connected to electric vehicle charging connector 100.

Linear actuator 150 is designed to secure housing 110 when housing 110 is in a closed state. Hosts may communicate to users-users defined as people seeking to charge their electric vehicle by way of lockbox 10 and hosts defined as people seeking to provide vehicle charging by way of their lockbox 10—what type of electric vehicle charging connectors 100 given lockboxes 10 hold. Linear actuator 150 in representative embodiments is a linear motor operating screw 151 going through latch 152 but could also include such rod designs as a plunger or could be a latch-and-hook design where the hook rotates into and out of the locked position. In such alternative embodiments, rod, not shown, would be located were screw 151 appears in the representative embodiment. In some embodiments, a magnet assembly may further be used to keep housing 110 in a closed state, even when housing 110 is in an unlocked state until users physically open housing 110.

Housing 110, when in a closed state, is designed to have or to form at least one aperture 160 arranged for passage of charging cable 195 connected to electric vehicle charging connector 100. Embodiments of lockbox 10 further include a means of sensing, such as with the aforementioned IR emitter 180 current and IR sensor 181, when electric vehicle charging connector 100 is held by holder assembly 120.

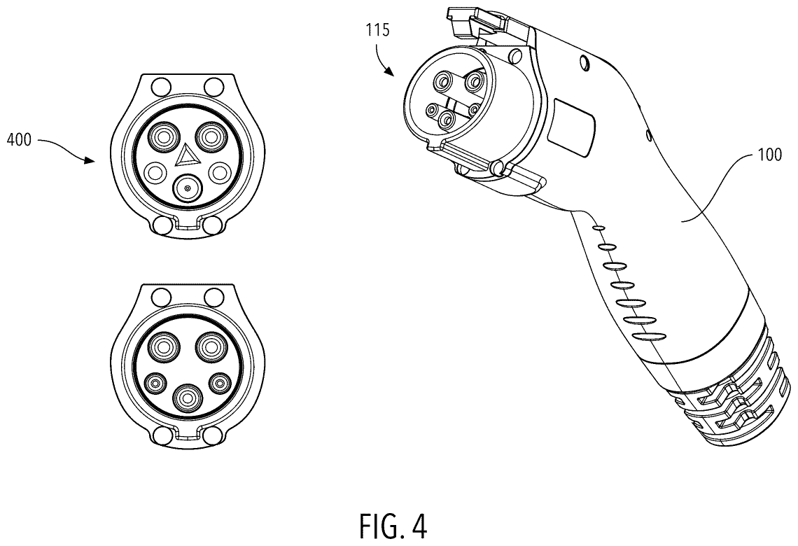

Some embodiments of lockbox 10 further include a second bracket 122B mounted to floor 111, to be able to hold and store, as illustrated in FIG. 4, at least one adapter 400 operatively arranged to plug into electric vehicle charging connector 100, adapter 400 arranged to enable electric vehicle charging connector 100 to engage at least one type of electric vehicle.

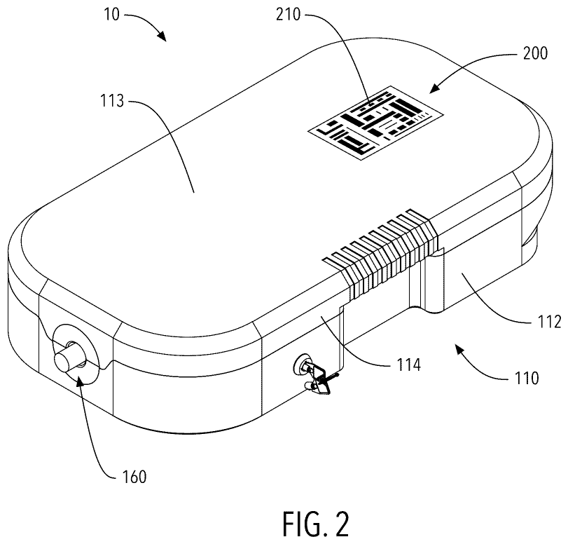

FIG. 2 illustrates a representative embodiment of lockbox 10 for electric vehicle charging connector 100 wherein housing 110 is in a closed stated. At least one machine-readable code 200, such as QR code 210 is disposed on cover 125 but may be located on any convenient part of lockbox 10.

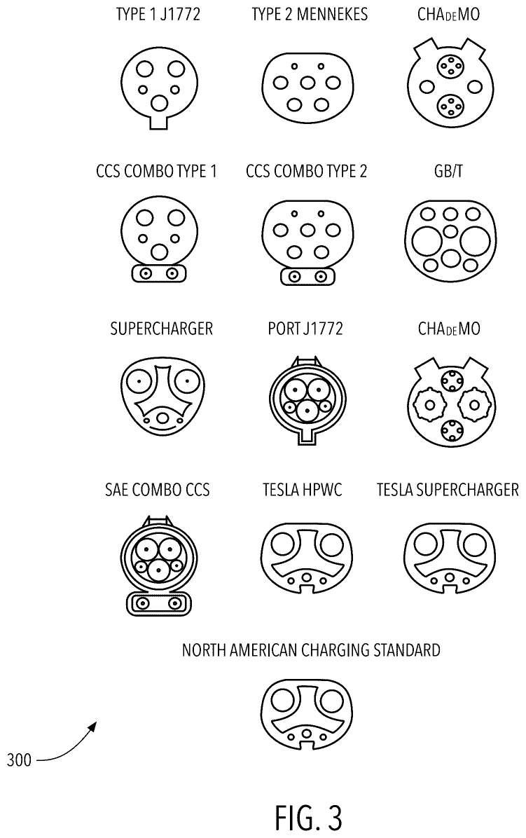

FIG. 3, illustrates charging port 300 that may include one or more types including, but not limited to: (SAE J1772), (IEC 62196), CCS1 (Type 1 base), CCS2 (Type 2 base), CHAdeMO, and Tesla Connectors. Illustrated and considering variations in naming are Type 1 J1772, TYPE 2 MENNEKES, CHAdeMO, CCS COMBO TYPE 1, CCS COMBO TYPE 2 GB/T, SUPERCHARGER, PORTJ1772, SAE COMBO CCS, TESLA HPWC, TESLA SUPERCHARGER, and NACS or North American Charging Standard connectors, wherein the invention, unless otherwise limited by a given claim, is not limited by the type of electric vehicle charging connector 100 used or charging port 300 used but by the fact that it has at least one electric vehicle charging connector 100 having at least one vehicle charging port 300.

FIG. 4 illustrates example adapters 400 that can be coupled with electric vehicle charging connector 100 to allow charging more than one type of vehicle without requiring more than one electric vehicle charging connector 100.

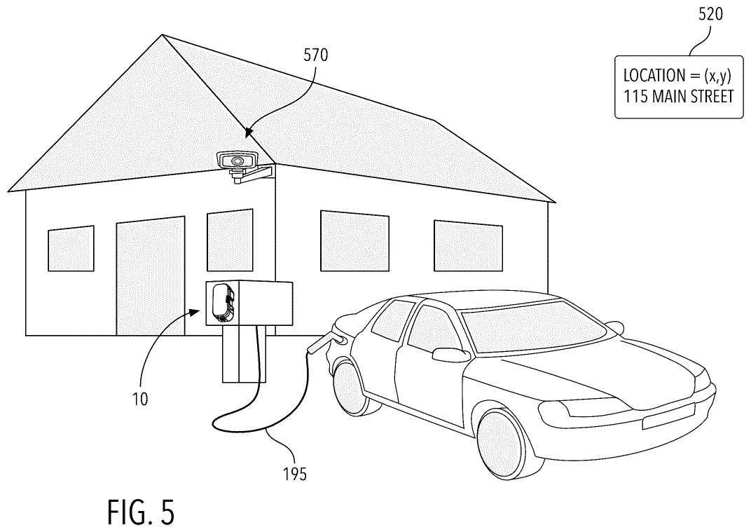

FIG. 5 illustrates that total time of electric vehicle charging connector 100 use, connected by way of charging cable 195, may be determined by external means such as by way of images from an associated optical sensor such as a camera 570. Some embodiments of lockbox 10 are further designed to communicate lockbox 10 coordinate 520—which may be done visually such as by placing an icon on an electronic map—to present the geographic location of lockbox 10 and could also be a postal or facility address.

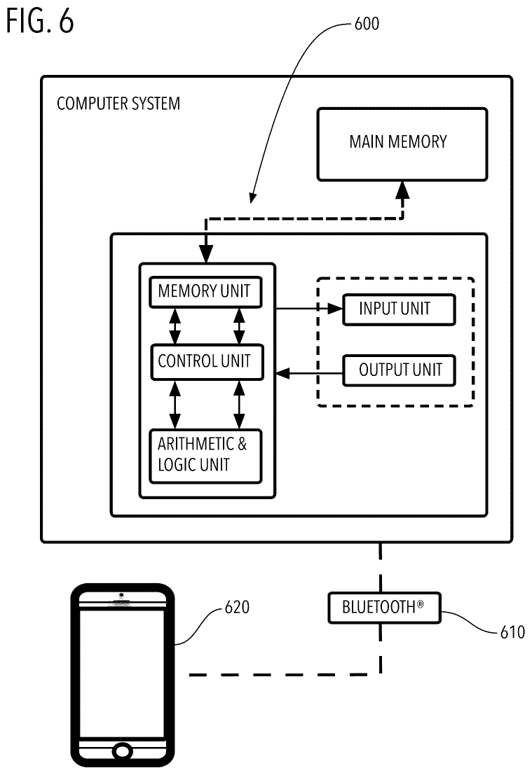

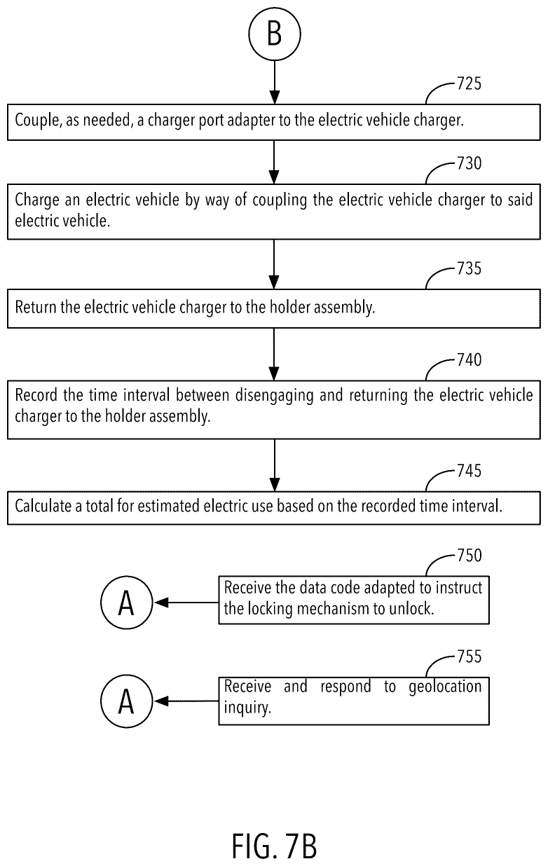

FIG. 6 illustrates that in some embodiments of lockbox 10, at least one computer processor 600 is designed to control linear actuator 150, which may include a Bluetooth® Low Energy (BLE) Microcontroller 615, illustrated in FIG. 8. In some embodiments of lockbox 10, linear actuator 150 is designed to be instructed to unlock by way of, as illustrated by FIG. 2, at least one machine-readable code 200, such as QR code 210. Other embodiments may be automated but relegate computer processing to devices outside housing 110 wherein automation inside housing 110 is designed to function as or in response to a switch assembly to perform such actions as locking and unlocking housing 110. Further, while housing 110 could include wi-fi for communication with users and hosts, the preferred embodiment includes Bluetooth® 610 or a comparable transceiver assembly that communicates wirelessly to users and hosts by way of a handheld computerized device 620 such as a smartphone. Some embodiments of lockbox 10 may have entirely mechanical access means such as by way of a physical key or a lock combination, not shown. Some embodiments could further be accessed or rendered accessible by other approved devices such as a credit card or bank card code, a debit card, a blockchain code, or biomarkers such as fingerprints or voice signals.

Communication includes such activities as helping users find a given lockbox 10 or select a given lockbox 10 among many potentially available lockboxes 10. For illustration, a user may determine the whereabouts of nearby lockboxes 10 based on receiving and perhaps determining the strength of a Bluetooth® signal from Bluetooth® transceiver 610. That Bluetooth® signal may include such information as coordinate 520, illustrated in FIG. 5, or other such data that will provide users with a way to determine the location of lockbox 10. Lockbox 10 is also designed to provide users with information about whether lockbox 10 is in use and may include information such as a commitment by another user scheduled to use lockbox 10. Lockbox 10 locations may also be presented on an app independent of whether a user has received, directly or by that user's computerized handheld device 620, a signal originating at lockbox 10.

In some embodiments of lockbox 10, linear actuator 150 is designed to be instructed to unlock by way of a user-entered code. In some embodiments, lockbox 10 may identify a user's handheld computerized device 620 or identity and transactions may take place without a specific user code but based on the proximity of the user to given lockbox 10.

As was illustrated in FIG. 2, to facilitate many potential transaction and security modes, some embodiments of lockbox 10 include, on housing 110 or a nearby adjunct assembly, machine-readable code 200, such as QR code 210, or a user-readable code such as a series of digits or numbers, wherein methods of use of lockbox 10, can be initiated by the information on or about lockbox 10 along with availability and time slots, and host ratings, where the information disposed on or about lockbox 10 directs users to an Internet site. Users, in some embodiments, may provide, or provide access to, their identifying information, such as payment information and means, car type, personal identification, debit or credit cards, monetary preloads which may be provided by the host or an associated enterprise, and customer ratings, by way of communicating to an Internet site to which their computerized handheld device 620 is directed from information disposed on or about lockbox 10.

In some embodiments of lockbox 10, computer processor 600 is designed to communicate a geographic location of lockbox 10 as might be done with a network of lockboxes 10 where coordinate 520 information is loaded on an app. Although this computer processor 600 may include a power source and memory to perform tasks independently, all or part of computer processing may be performed on an associated computerized handheld device 620 and app, including transactions and such operations as determining, monitoring, and obtaining remuneration for electric vehicle charging.

Although embodiments may include electric metering, preferred embodiments determine electric vehicle charging transactions by way of time, for illustration, seeking payment for a period of charging an electric vehicle from the moment or shortly thereafter that electric vehicle charging connector 100 is removed from holder assembly 120 to the moment or shortly therebefore electric vehicle charging connector 100 is returned to holder assembly 120 or by some fractional unit or charge such as all of any given minute electric vehicle charging connector 100 was apart from holder assembly 120.

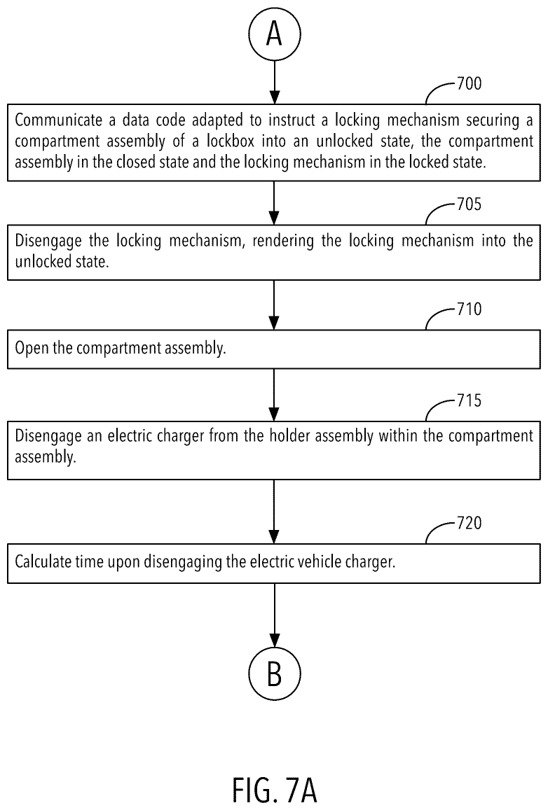

Further disclosed in FIGS. 7A and 7B is a method for operating lockbox 10 for electric vehicle charging connector 100, the method including the step of 700, communicating a data code designed to instruct motorized locking mechanism 150 securing housing 110 of lockbox 10 into an unlocked state, housing 110 in the closed state and motorized locking mechanism 150 in the locked state. The method further includes the step of 705, disengaging motorized locking mechanism 150, rendering motorized locking mechanism 150 into the unlocked state. The method further includes the step of 710, opening housing 110. The method further includes the step of 715, disengaging electric vehicle charging connector 100 from holder assembly 120 within housing 110. The method further includes the step of 720, calculating time upon disengaging electric vehicle charging connector 100. The method further includes the step of 725, coupling, as needed, charging port adapter 400 to electric vehicle charging connector 100. The method further includes the step of 730, charging an electric vehicle by way of coupling electric vehicle charging connector 100 to that given electric vehicle. The method further includes the step of 735, returning electric vehicle charging connector 100 to holder assembly 120. The method further includes the step of 740, recording the time interval between disengaging and returning electric vehicle charging connector 100 to holder assembly 120. The method further includes the step of 745, calculating a total for estimated electric use charge based on the recorded time interval.

The method may further include the step of 750, receiving the data code designed to instruct linear actuator 150 to unlock. The method may further include the step of 755, receiving a geolocating inquiry from said computerized mobile device and communicating geolocation of lockbox 10 to said computerized mobile device.

To further aid in locating selected lockbox 10, lockbox 10 may be painted an identifying color where the color may be used simply to identify lockbox 10 as being for electric vehicle charging and where the color may also be a contrasting color to help users visually spot lockbox 10 cither with the naked eye or by some augmenting system such as handheld communication device 620. The method may further include peer-to-peer feedback about users and hosts as a tool to help create reliable transactions.

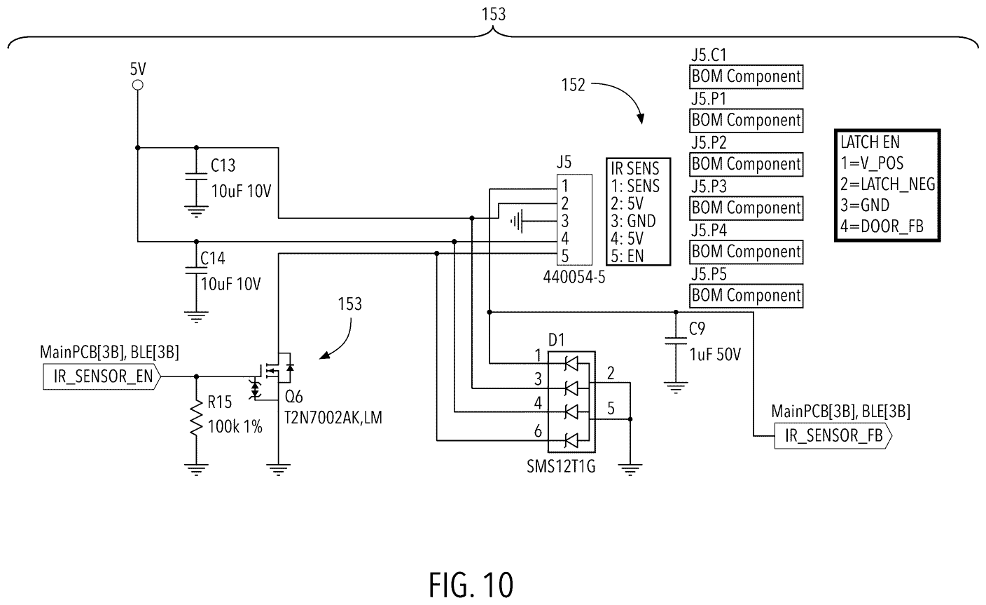

FIG. 8 illustrates a representative hierarchical circuit layout of components that will follow and include a Bluetooth® Low Emission (BLE) Microcontroller 615 as would be integrated within container assembly 110. This figure and the following figures illustrate one of many possible embodiments of the invention, including, in some cases, representative part numbers, models, and performance specifications but not limited to those part numbers, models, and performance specifications. Representative Bluetooth® transceiver 610 is part of a control system that includes a power circuit 171 designed to manage its operation, external IO 192, illustrated in FIG. 11, designed for communication and control, door lock circuit 153 designed to secure container assembly 110, and IR sensor 181 designed to detect the presence or absence of items within container assembly 110 such as electric vehicle charging connector 100. Bluetooth® transceiver 610 typically interfaces with handheld computerized device 620, enabling users to control access to container assembly 110 via a mobile app. When a user commands access through their handheld computerized device 620, Bluetooth® transceiver 610 processes the signal, activates power circuit 171, and engages door lock circuit 153 to unlock or lock container assembly 110. Simultaneously, IR sensor 181 within container assembly 110 provides real-time feedback on disposition of electric vehicle charging connector 100, ensuring that the system can monitor and manage electric vehicle charging connector 100 securely stored inside.

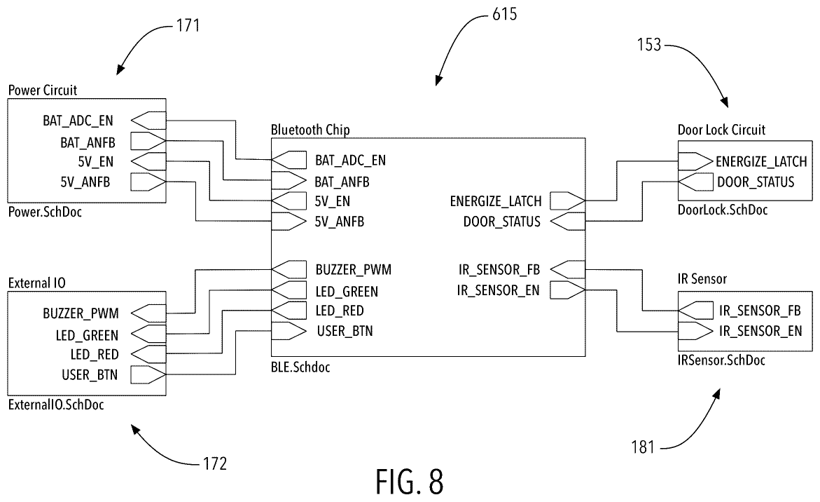

FIG. 9 illustrates a representative power schematic of representative power circuit 171, including:

### Power Supply Description

a) Power Source is, in this representative embodiment, a battery, but other sources could be used such as solar or combinations of solar power and solar rechargeable batteries.
Battery assembly 170 within or about the container assembly 110. Representative batteries 170 include:
Using 4×AA batteries in series.
Expected voltage range: 4V-6V.
Expected battery life: 2.5 years.
b) Reverse Polarity Protection 172, which is designed to protect against users improperly installing batteries.
VGS Minimum/Maximum: +8V
VGS Threshold: −0.9V
Battery Voltage Measurement Circuitry 173, which is designed to measure voltage.
Voltage at the Common Collector VCC 174, which is designed to supply power.
Power booster 175, which is designed to boost power from 3V to 5V for sensor designed to detect that electric vehicle charging connector 100 is present in lockbox 10 and to operate linear actuator 150. Power booster 175 also is designed to allow greater longevity of battery sources.
On Resistance: 60 mOhm at 4V, 75° C.
Thermal Resistance (t<10 s): 64° C./W
c) Power Consumption

$$Power Draw :$$

$$2.03 {A}^{2} * 0.06 Ohm = 247 mW$$

$$Temperature Rise :$$

$$64 ° C . / W * 0.25 W = 16 ° C .$$

Quiescent Current:
17 μA when enabled.
3.5 μA into VIN/SW when disabled.
d) Efficiency
3V Bus:
Greater than 90% efficiency at Vin=3.6V-5V, Vout=3.3V, I=2A.
Assuming 85% efficiency for extreme conditions.
5V Bus:

$$Greater than 95 \% efficiency at Vin = 3 V , Vout = 5 V , Iout = 1.1 A .$$

Assuming 85% efficiency for extreme conditions.
e) Current Draw
3V Bus Current Draw:
Total: 2300 mA
Components:
MCU: 15 mA
IR Sensor Receiver: 0.13 mA
Red LED: 30 mA
Green LED: 25 mA
5V Bus: 2220 mA
5V Bus Current Draw:
Maximum: 1132 mA
Components:
Latch Mechanism: 1.1 A
IR Sensor Emitter: 32 mA
Current Draw on 3V Bus: 5V bus current draw on the 3V bus.
f) Additional Notes
Power Good (PG) Pin:
Should float if not used.
Enable (EN) Pin:
Has an internal 500 kOhm pull-down when the system is disabled.

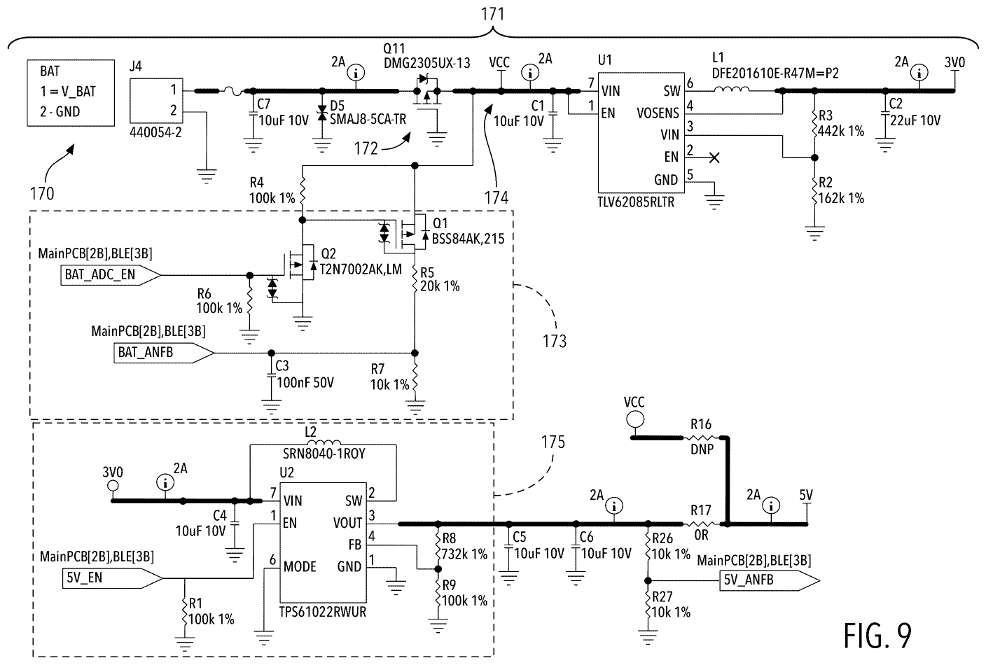

FIG. 10 illustrates representative door latch mechanism 153 with latch 152 in one representative embodiment rated for 5V and has a nominal rating of 1.1A, further designed to provide feedback as to whether latch 152 is open or closed. Testing at room temperature shows, in this representative embodiment, a constant current draw of 920 mA during energizing. The power calculations use the 1.1A rating. Both connectors run to switch 154 located inside latch 152. When unlocked, this switch 154 opens. Latch 152 comes with SMR-02V-B for latch 152 and SMP-02V-BC for feedback. These connectors, in this embodiment, do not have mating PCB-mounted connectors. Therefore, SM connectors can be cut off, and associated wires can be crimped with the specified TE parts.

FIG. 11 illustrates a representative External IO circuitry 192 embodiment that includes:
g) Red Pathway:
Forward Voltage: 1.8 V
Steady Current: 10 mA
Resistor Calculation: R19-3.0 V−1.8/V10 mA=120Ω
h) Green Pathway:
Forward Voltage: 1.9 V
Steady Current: 10 mA
Resistor Calculation: R20=3.0 V−1.9/V10 mA=110Ω.
Resistor Selection: Choosing 2×110Ω
i) Additional Notes:
Piezo Element:
A 1 k resistor is recommended for charging and discharging the piezo element.
GPIO Specifications:
GPIO pins can source/sink a maximum of 50 mA.
MCU Configuration:
The MCU is designed to use an internal 44 k pull-up resistor.
RC Time Constant Calculation: RC=44 kΩ×100 nF=4.4 ms
j) Component:
D2: Included as part of external IO 192 embodiment.

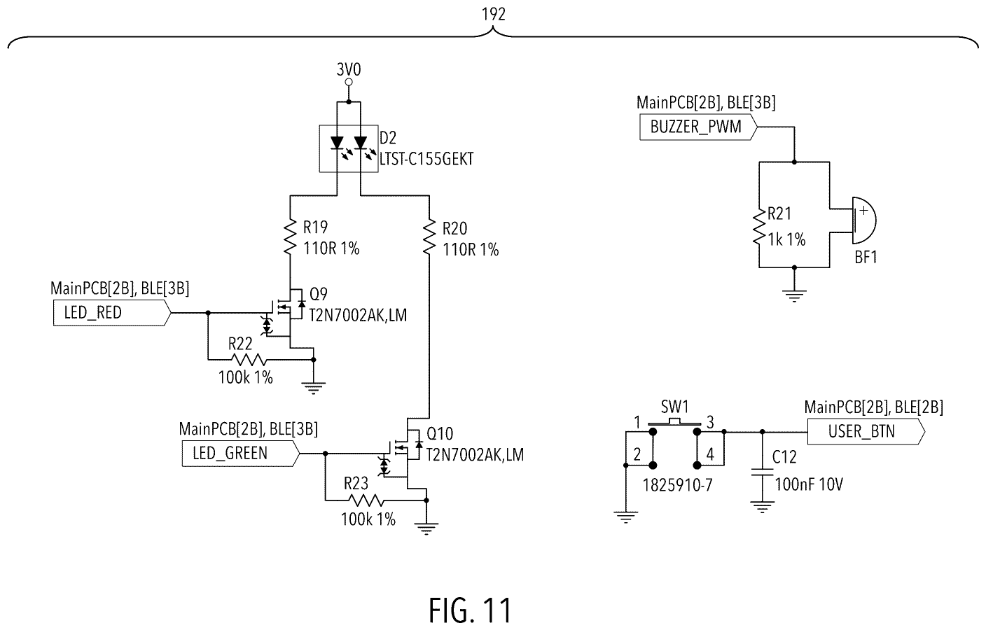

FIG. 12 illustrates a representative Bluetooth® Low Energy (BLE) Microcontroller 615 Description, including:
a) Power and Reset
Decouple Pin:
Exposes the SoC's on-chip digital supply regulator.
Default recommendation is to leave pin unconnected (NC′ed).
Reset Pin:
Has an internal pull-up; external pull-up is not required.
b) RF and Debug Pins
RF Pin:
Should either be shorted to GND when not used or connected to a 50 Ohm connector.
TDI (Test Data In):
Disabled after reset, with a built-in pull-up.
TDO (Test Data Out):
Disabled after reset.
SWDIO (Serial Wire Debug I/O):
Enabled after reset, with a built-in pull-up.
SWCLK (Serial Wire Debug Clock):
Enabled after reset, with a built-in pull-down.
c) General-Purpose I/O (GPIO)
Current Sourcing/Sinking:
GPIO pins can source/sink a maximum of 50 mA each, with a total maximum of 200 mA across all pins.
PWM Signals:
Connected to TIMER peripherals.
Timers:
TIMER0 and TIMER1: Available on all four ports.
TIMER2: Available on PA and PB ports.
TIMER3: Available on PC and PD ports.
LETIMER0: Available on PA and PB ports.
d) Analog to Digital Converter (IADC)
Antenna 611
Availability:
Available on all four GPIO ports.
With single-ended connections, any pin may be used.
Analog Signal Voltage Limitation:
Section 24.3.12.2 of the EFR32×G21 reference manual states analog signal voltages are limited by AVDD.
Section 12.3 shows AVDD is directly connected to VDD (3V3 bus).
e) Connectivity
J2 Connector:
Should match the DMC USB-UART breakout board (BLE TX connects to debugger RX).
f) Capacitors
Decoupling and Filtering Capacitors:
g) Power
5V_EN:
Connected to MainPCB [2B] and Power [3C].

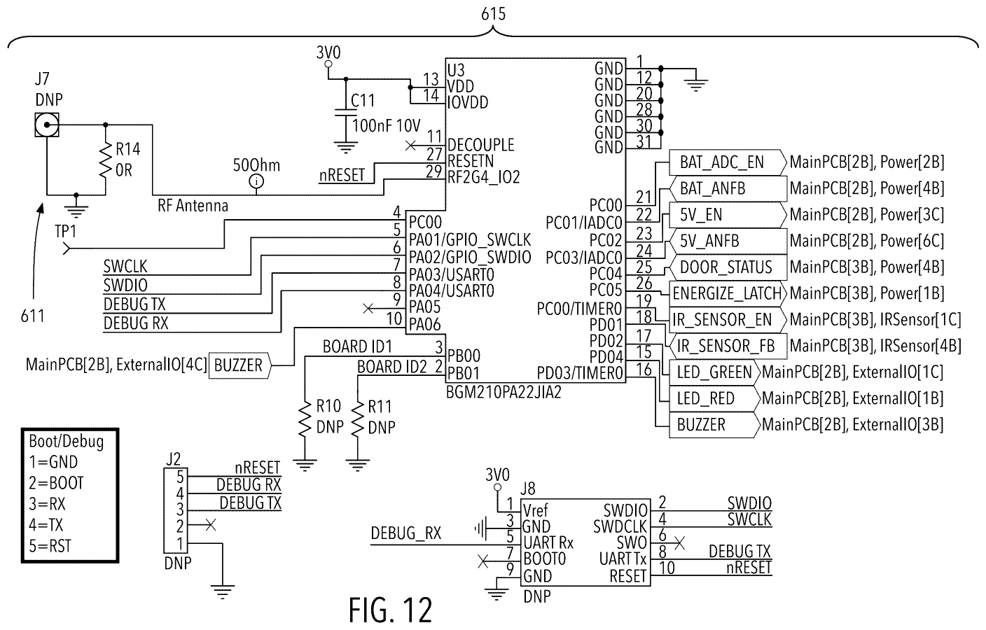

FIG. 13 illustrates a representative embodiment wherein RFID reader 185 is mounted on base sidewall 112 of housing 110, continuously monitoring the presence of RFID tag 182 attached to electric vehicle charging connector 100 stored within housing 110. This system is designed to detect when electric vehicle charging connector 100 is removed and when electric vehicle charging connector 100 is returned. When electric vehicle charging connector 100, equipped with RFID tag 182, is inside housing 110, RFID reader 185 recognizes the signal and confirms its presence. Upon removal of electric vehicle charging connector 100, RFID reader 185 senses the absence of an RFID signal, triggering an alert or recording the event in a log. Similarly, when electric vehicle charging connector 100 is placed back into housing 110, RFID reader 185 detects an RFID signal once again, indicating that electric vehicle charging connector 100 has been returned. The representative embodiment includes RFID tag 182 disposed on cable 195. Other locations for RFID tag 182 include electric vehicle charging connector 100.

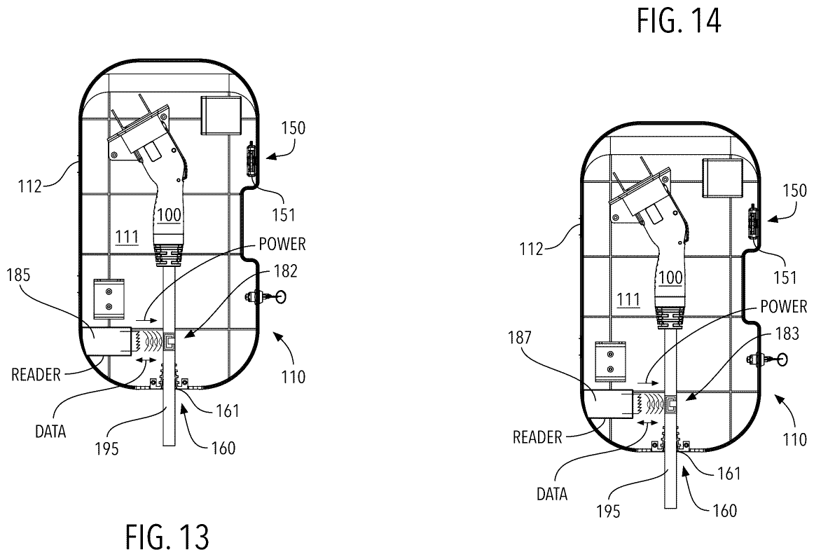

FIG. 14 illustrates a representative embodiment wherein NFC reader 187 is mounted on base sidewall 112 of housing 110, continuously monitoring the presence of NFC tag 183 attached to electric vehicle charging connector 100 stored within housing 110. This system is designed to detect when electric vehicle charging connector 100 is removed and when electric vehicle charging connector 100 is returned. When electric vehicle charging connector 100, equipped with NFC tag 183, is inside housing 110, NFC reader 187 recognizes the signal and confirms its presence. Upon removal of electric vehicle charging connector 100, NFC reader 187 senses the absence of an NFC signal, triggering an alert or recording the event in a log. Similarly, when electric vehicle charging connector 100 is placed back into housing 110, NFC reader 187 detects an NFC signal once again, indicating that electric vehicle charging connector 100 has been returned. The representative embodiment includes NFC tag 183 disposed on cable 195. Other locations for NFC tag 183 include electric vehicle charging connector 100.

An alternative embodiment, not shown, is a mechanical switch that would be in on or off states depending on whether electric vehicle charging connector 100 is within holder 120.

Various related embodiments of the inventive concept are also described in the drawings, which are incorporated herein by reference in their entirety.

While inventive concepts have been described above in terms of specific embodiments, it is to be understood that the inventive concepts are not limited to these disclosed embodiments. Representative examples may, in other embodiments, use different values, for example, in the circuitry, while maintaining the overall function of the disclosed invention. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

### REFERENCE NUMBERS

10 Lockbox
100 Electric vehicle charging connector
110 Housing
111 Floor
112 Base sidewall
113 Ceiling
114 Lip
115 Coupler
117 Base member
118 Cover member
120 Holder assembly
122 Bracket
122A First bracket
122B Second bracket
125 Cover
150 Linear actuator
151 Screw
152 Latch
153 Door latch mechanism
154 Switch
160 Aperture
161 First notch
162 Second notch
165 Hinge
170 Battery assembly
171 Power circuit
172 Reverse polarity protection
173 Battery voltage measurement circuitry
174 Voltage at the Common Collector (VCC)
175 Power booster
180 Infrared (IR) Emitter
181 Infrared (IR) Sensor
182 RFID tag
183 NFC tag
184 IR sensor terminal
185 RFID Reader
187 NFC Reader
188 Emitter MOSFET
189 Receiver MOSFET
192 External IO circuitry
195 Charging cable
200 Machine-readable code
210 QR Code
300 Charging port
400 Adapter
520 Coordinate
570 Camera
600 Computer processor
610 Bluetooth® transceiver
611 Antenna
615 Bluetooth® Low Energy (BLE) Microcontroller
620 Handheld computerized device
700-755 Lockbox Method

What is claimed is:

1. A lockbox for an electric vehicle charging connector, comprising:
a housing comprising a base member and a cover member hingedly connected to one another, said base member having a floor and a base sidewall emanating substantially perpendicularly upwardly from said floor, said cover member having a ceiling and a lip emanating substantially perpendicularly downwardly from said ceiling;
a latch fixedly secured to said ceiling, said latch having an aperture therein;
a linear actuator secured to said floor, said linear actuator having a screw, said linear actuator operatively arranged to extend said screw through said aperture to lock said cover member to said base member;
a first bracket mounted to said floor, said first bracket operatively arranged to hold said electric vehicle charging connector;
an infrared sensor mounted within said lockbox, operatively arranged to sense if said electric vehicle charging connector is being held within said first bracket;
a computer processor operatively arranged to control said linear actuator; and
a Bluetooth® transceiver mounted within said lockbox, operatively arranged to receive a signal from a mobile device and to communicate said signal to said computer processor to verify the signal and control said linear actuator.

2. The lockbox recited in claim 1 wherein the base sidewall includes a first notch and said cover sidewall includes a second notch in registration with said first notch such that, when said cover is closed upon said base, said first and second notches form an aperture operatively arranged to hold a charging cable.

3. The lockbox recited in claim 1 wherein said electric vehicle charging connector comprises a Type 1 (SAE J1772) connector.

4. The lockbox recited in claim 1 wherein said electric vehicle charging connector comprises a Type 2 (IEC 62196) connector.

5. The lockbox recited in claim 1 wherein said electric vehicle charging connector comprises a CHAdeMO-type connector.

6. The lockbox recited in claim 1 wherein said electric vehicle charging connector comprises a CCS-type connector.

7. The lockbox recited in claim 1 wherein said electric vehicle charging connector comprises a Tesla-type connector.

8. The lockbox recited in claim 1 wherein said electric vehicle charging connector comprises a NACS or North American Charging Standard.

9. The lockbox recited in claim 1, further comprising a second bracket mounted to said floor, said second bracket operatively arranged to hold and store at least one adapter operatively arranged to plug into said electric vehicle charging connector to enable said electric vehicle charging connector to engage a connector consisting of the group Type 1 (SAE J1772), Type 2 (IEC 62196), CHAdeMO, Tesla, NACS or North American Charging Standard, and CCS.

10. A lockbox for an electric vehicle charging connector, comprising:
a housing comprising a base member and a cover member operatively arranged to be connected to one another to form a compartment, said base member having a floor, said cover member having a ceiling;
a latch fixedly secured to said ceiling, said latch having an aperture therein;
a linear actuator secured to said floor, said linear actuator having a screw or rod, said linear actuator operatively arranged to extend said screw or rod through said aperture to lock said cover member to said base member;
a computer processor operatively arranged to control said linear actuator; and
a transceiver mounted within said lockbox, operatively arranged to receive a signal from a mobile device and to communicate said signal to said computer processor to verify the signal and control said linear actuator.

11. The lockbox recited in claim 10, wherein the transceiver is Bluetooth®.

12. The lockbox recited in claim 10 wherein the base sidewall includes a first notch and said cover sidewall includes a second notch in registration with said first notch such that, when said cover is closed upon said base, said first and second notches form an aperture operatively arranged to hold a charging cable.

13. The lockbox recited in claim 10 wherein said electric vehicle charging connector comprises a Type 1 (SAE J1772) connector.

14. The lockbox recited in claim 10 wherein said electric vehicle charging connector comprises a Type 2 (IEC 62196) connector.

15. The lockbox recited in claim 10 wherein said electric vehicle charging connector comprises a CHAdeMO-type connector.

16. The lockbox recited in claim 10 wherein said electric vehicle charging connector comprises a CCS-type connector.

17. The lockbox recited in claim 10 wherein said electric vehicle charging connector comprises a Tesla-type connector.

18. The lockbox recited in claim 10 wherein said electric vehicle charging connector comprises a NACS or North American Charging Standard.

19. The lockbox recited in claim 9, further comprising a second bracket mounted to said floor, said second bracket operatively arranged to hold and store at least one adapter operatively arranged to plug into said electric vehicle charging connector to enable said electric vehicle charging connector to engage a connector consisting of the group Type 1 (SAE J1772), Type 2 (IEC 62196), CHAdeMO, Tesla, NACS or North American Charging Standard, and CCS.

20. A method of operating an electric vehicle charging connector in a lockbox including:
receiving a signal containing a code from a computerized mobile device with a receiver located inside said lockbox;
comparing said received code with a stored code to confirm that the received code matches the stored code; and
activating a linear actuator to unlock said lockbox if and only if said received code matches said stored code.

21. The method of operating an electric vehicle charging connector in a lockbox of claim 19, further including permitting electricity to charge a connected electric vehicle;
estimating the charge used to charge the electric vehicle; and
recording the estimated charge.

22. The method of locking an electric vehicle charging connector in a lockbox of claim 19, further including:
sensing that said electric vehicle charging connector is inside said lockbox; and
activating a linear actuator to lock said lockbox.

23. The method of locking an electric vehicle charging connector in a lockbox of claim 19, further including receiving a geolocating inquiry from said computerized mobile device, and
communicating geolocation of said lockbox to said computerized mobile device.
